(19) United States
(12) Patent Application Publication
(10) Pub. No.: US 2007/0081081 A1
(43) Pub. Date: Apr. 12, 2007

(54) Automated multi-frame image capture for panorama stitching using motion sensor

(76) Inventor: Brett Anthony Cheng, Vancouver (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/246,943

(22) Filed: Oct. 7, 2005

(51) Int. Cl. H04N 5/225

(52) U.S. Cl. 348/218.1

(57) ABSTRACT

A method and apparatus for capturing a plurality of overlapping images using an imaging device are described. The method includes receiving input indicating a start of a multi-image capture, input indicating an end of a multi-image capture, and storing a current image. Each time an amount of rotation of the imaging device about at least one axis exceeds a displacement angle, a new current image is stored until the input indicating the end of the multi-image capture is received.

### BACKGROUND

In traditional film photography, it is known to take multiple pictures of a field of view, each at different angles, and then overlap the resulting prints to obtain a single larger image having a wider field of view. Thus, each photograph is an image that is overlapped with preceding and/or successive images to produce the larger, final image. The overlapping technique can be used to provide extra wide-format pictures, commonly referred to as “panorama” pictures. However, the overlapping technique can also be used to generate extra tall pictures and pictures that are extra large, providing a wider angle of view in both the horizontal and vertical directions.

One unique aspect of digital imaging is the ability to digitally process and manipulate the image after the image is stored. Often, this entails transferring image data to a general purpose computer and manipulating the image using imaging software. It is known, for example, to take overlapping images of a scene and then digitally stitch the images together to form a single larger image. The images may even be automatically aligned by computer software by detecting edges and using other known techniques, then combined into a single larger image.

Modern hand-held digital imaging devices include dedicated digital cameras, as well as cell phones, personal digital assistants (PDAs), and other devices incorporating digital imaging functionality. The imaging system in these devices includes an image sensor and various electronics to pass the image from the sensor to a display and/or to memory. Some digital imaging devices such as mid-range and high-end digital cameras include functionality to assist the photographer to produce overlapping images. For example, in a “panorama mode,” it is known to provide in a liquid crystal display (LCD) both the previous image, and a live view, to permit the photographer to manually determine where to position the camera to provide an appropriate amount of overlap. In some prior art devices, the user may select the panning direction (up, down, left, or right) and the camera would then orient the previous image in the display so that the overlapped portion of the previous image would be adjacent the live image, to further assist the photographer. However, in these cases, the photographer is still required to manually align each successive overlapping image with the previous one, and each image must be separately stored by pressing the shutter release.

There therefore exists an unmet need to provide an automated yet reliable mechanism for producing overlapping digital images and for creating composite images using overlapping images.

### SUMMARY

Broadly speaking, the present invention fills these needs by providing an imaging device capable of automating the capture of overlapping images.

It should be appreciated that the present invention can be implemented in numerous ways, including as a process, an apparatus, a system, a device, or a method. Several inventive embodiments of the present invention are described below.

In one embodiment, a method and apparatus for capturing a plurality of overlapping images using an imaging device are described. The method includes receiving user input indicating a start of a multi-image capture and storing a current image. Each time an amount of rotation of the imaging device about at least one axis exceeds a displacement angle, a new current image is stored. User input indicates an end of the multi-image capture.

Other aspects and advantages will become apparent from the following detailed description, taken in conjunction with the accompanying drawings, illustrating by way of example the principles of the invention.

### BRIEF DESCRIPTION OF THE DRAWINGS

The embodiments will be readily understood by the following detailed description in conjunction with the accompanying drawings, and like reference numerals designate like structural elements.

FIG. 1 shows a schematic overview of an imaging device.

FIG. 2 shows an exemplary imaging device in the form of a digital camera.

FIG. 3 shows an example use of the imaging device in one mode of operation.

FIG. 4 shows how overlapping images can be stitched together to create a final image.

FIG. 5 shows a flowchart describing an exemplary procedure for taking a plurality of overlapping images using an imaging device.

FIG. 6 is a flowchart showing an exemplary method for generating a plurality of overlapping images.

FIG. 7 shows detail view of the rear panel of the imaging device during multi-image capture.

### DETAILED DESCRIPTION

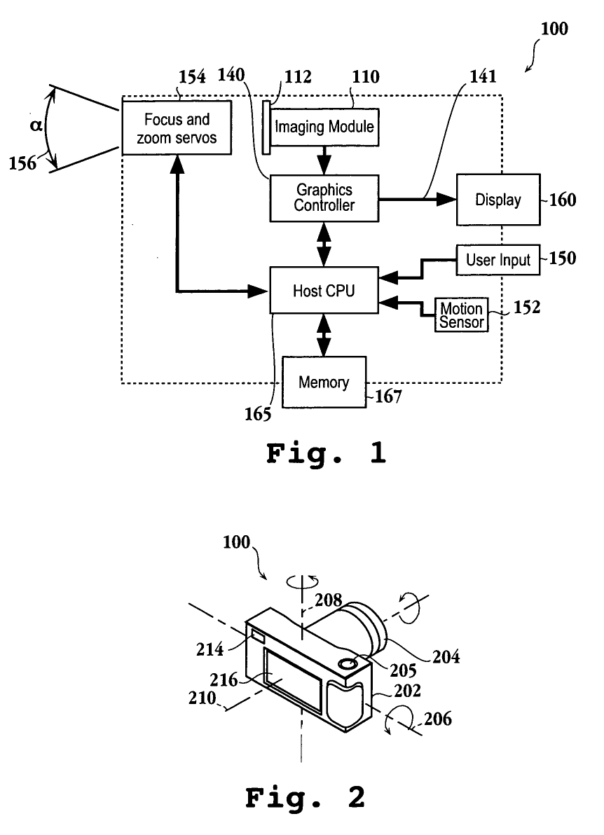

FIG. 1 is a schematic overview of an imaging device 100. Imaging device 100 may be a digital camera, digital video recorder, or some electronic device incorporating a digital camera or video recorder functionality, such as, for example, a personal digital assistant (PDA), cell phone or other communications device. Imaging device 100 includes an imaging module 110, a graphics controller 140, a host central processing unit (CPU) 165, and a display 160.

The timing control signals and data lines, such as line 141 communicating between graphics controller 140 and display 160, are shown as a single line but may in fact be several address, data, and control lines and/or a bus. All communication lines shown in the figures will be presented in this manner except as noted to reduce the complexity and better present various novel aspects of imaging device 100.

Imaging module 110 includes an image sensor 112 positioned adjacent to a lens (not shown) such that light is focused on and forms an image on the sensor. Imaging module 110 and image sensor 112 may be combined into a single integrated circuit or exist as separate integrated circuits. Image sensor 112 may be a charge-coupled device (CCD) or complementary metal-oxide semiconductor (CMOS) type image sensor that converts light into electronic signals that represent the level of light at each pixel. Other image sensors that are known or may become known that are capable of converting an image formed by light onto a surface into electronic signals representative of the image may also be used. Imaging module 110 then converts these electronic signals into image data, which is passed to graphics controller 140. Imaging module 110 may have varying resolutions depending upon the application. In one embodiment, image sensor 112 comprises a two-dimensional array of pixel sensors in which each pixel sensor has a color filter in front of it in what is known as a color filter array (CFA). One common type of CFA is the Bayer filter in which every other pixel has a green filter over it in a checkerboard pattern, with remaining pixels in alternate rows having blue and red filters. Other types of color image sensors are available or may become available that are contemplated for use with imaging device 100. In addition, the present invention may also be used with a gray-scale image sensor used for taking black and white photographs.

Graphics controller 140 receives image data from imaging module 110, and, in accordance with instructions from host CPU 165, can send the image data to display 160 or host CPU 165. Graphics controller 140 may include image processing capabilities such as image compression technology for converting image data received from imaging module 110 into compressed image data.

Display 160 can be any form of display capable of displaying an image. In one embodiment, display 160 comprises a liquid crystal display (LCD). However, other types of displays are available or may become available that are capable of displaying an image that may be used in conjunction with imaging device 100. Although imaging module 110 and display 160 are presented as being part of imaging device 100, it is possible that one or both of imaging module 110 and display 160 are external to or even remote from each other and/or graphics controller 140. For example, if imaging device 100 can be used as a security camera or baby monitor, it may be desirable to provide a display 160 that is separable from or remote to the imaging module 10 to provide monitoring capability at a remote location. In another embodiment, e.g., for a compact camera, display 160 is not provided. In this case, the photographer may rely on an optical viewfinder or other means for aligning image sensor 112 with the intended subject.

Host CPU 165 performs digital processing operations and communicates with graphics controller 140. In one embodiment, host CPU 165 comprises an integrated circuit capable of executing software retrieved from memory 167. This software provides imaging device 100 with functionality when executed on host CPU 165. Host CPU may also be a digital signal processor (DSP) or other processing device.

Memory 167 may be internal or external random-access memory or non-volatile memory. Memory 167 may be non-removable memory such as flash memory or other EEPROM, or magnetic media. Alternatively, memory 167 may take the form of a removable memory card such as ones widely available and sold under such trademarks as “SD Card,” “Compact Flash,” and “Memory Stick.” Memory 167 may also be any other type of machine-readable removable or non-removable media. Memory 167 may be remote from imaging device 100. For example, memory 167 may be connected to imaging device 100 via a communications port (not shown). For example, imaging device 100 may include a BLUETOOTH® interface or an IEEE 802.11 interface, commonly referred to as “Wi-Fi.” Such an interface may connect imaging device 100 with a host (not shown) for uploading image data to the host. If imaging device 100 is a communications device such as a cell phone, it may include a wireless communications link to a carrier, which may then store data in hard drives as a service to customers, or transmit image data to another cell phone or email address. Memory 167 may be a combination of memories. For example, it may include a removable memory card for storing image data, and a non-removable memory for storing data and software executed by host CPU 165.

Host CPU 165 is also in communication with user input 150, motion sensor 152, and focus and zoom servos 154. In one embodiment, user input device 150 comprises a shutter button 205 (see FIG. 2). Alternatively, user input device 150 may comprise any number of alternate means, such as a keypad, a remote control, touch-screen, audio or voice command, etc. User input may include a mode selection dial or graphical interface buttons for selecting items on display 160. In response to user input, user input device 150 sends a signal to host CPU 165 causing data representing an image to be sent to memory.

Motion sensor 152 provides electronic signals to host CPU 165 indicating a relative rotation about at least one axis. In one embodiment, motion sensor 152 comprises a gyroscopic motion sensor, such as the Epson@ XV-3500 Gyro Sensor available from Epson Electronics America, Inc. of San Jose, Calif. This gyroscopic motion sensor is a vibration type sensor having no rotating parts. Other motion sensors or absolute position sensors, such as ones sensitive to the Earth's magnetic field and/or gravity, may also be used to determine relative rotation of imaging device 100.

FIG. 2 shows an exemplary imaging device 100 in the form of a digital camera having a body portion 202 and a lens portion 204. In this embodiment, imaging device 100 also includes a viewfinder 214 and liquid crystal display (LCD) 216. To create a plurality of overlapping images, imaging device 100 can be rotated on any of the x-axis (206) y-axis (208) or z-axis (210). Rotation about x-axis 206 is referred to as “pitch,” rotation about y-axis 208 is referred to as “yaw,” and rotation about z-axis 210 is referred to as “roll.” Motion sensor 152 may be a single axis, a dual axis, or a three-axis sensor for sensing movement on all three axes. In one embodiment, motion sensor 152 is a single-axis sensor that senses yaw or pitch only. In another embodiment, motion sensor 152 is a dual-axis sensor for sensing pitch and yaw. In yet another embodiment, motion sensor 152 is a three-axis sensor for sensing pitch, yaw, and roll. Any combination of sensors is possible depending upon the anticipated application.

Returning to FIG. 1, focus and zoom servos are provided for configuring a focusing lens (not shown) for producing an image of a subject on image sensor 112. In one embodiment, imaging device 100 includes a compound lens configuration comprising a plurality of lenses for providing variable focal-length, and a moving focal lens for focusing an image on image sensor 112. One servo mechanism may be provided for moving a focal lens toward and away from image sensor 112 and another servo mechanism may be provided for varying the focal length through an optical zoom apparatus in the known manner. Alternatively, other focus or zoom technologies that are known or that may become known may be used. Such technologies, for example, may rely on one or more shape-changing lenses and therefore have fewer or no moving parts. In this case, the term “focus and zoom servos” may be understood as encompassing such technologies.

Changing the focal length will affect the angle of view 156 (α). The angle of view may be measured horizontally, vertically, or diagonally, and will vary with the dimensions and aspect ratio of image sensor 112, as well as the focal length. In addition, imaging device 100 may include electronic zoom functionality, which can also affect angle of view 156. An electronic zoom is a feature of some imaging devices allowing a subset of pixel sensors at the center of image sensor 112 to define the image. As the zoom factor is electronically increased, a smaller and smaller subset of pixel sensors are employed, which causes a corresponding reduction in the angle of view. Thus, the angle of view will vary with both the optical zoom setting, which varies the focal length, and the electronic zoom setting, which effectively varies the size of the sensor.

In operation, a photographer may save a single image by orienting imaging device 100 such that a desired image is aligned with image sensor 112 of imaging module 110. Graphics controller 140 then passes resulting image data to either or both of display 160 and host CPU 165 for storage in memory. Imaging module 110 and/or graphics controller 140 may include image processing circuitry for compressing the image using an image compression algorithm such as the well known JPEG image format. It is also possible to have a system wherein the sensor data is not compressed at all, but stored in a “RAW” uncompressed format, and stored in this format in memory 167 for later processing in camera or using a general-purpose computer. In one mode of operation, display 160 is continuously updated with an image most recently received by imaging module 110. When the user inputs a desire to send data representing a current image to memory 167, the user will interact with user input device 150 causing an image received by imaging module 110 to be passed by graphics controller 140 to host CPU 165, and stored in memory 167. In one embodiment, imaging device 100 has at least two modes of operation. In one mode, only single images are taken for each interaction with user input device 150. In another mode of operation, imaging device 100 takes a series of overlapping images to be stitched together to form a single image having a larger angle of view.

Instead of or in addition to taking single still images, imaging device 100 may be capable of generating a video stream. In this case, graphics controller 140 may receive an image periodically, e.g., 30 times a second, which is then encoded using Moving Picture Experts Group (MPEG) or other encoding technology and stored in memory 167. In the case of a video recording device, motion sensor 152 may be used both for capturing overlapping still images of a scene as will be described in more detail below, and for electronically compensating for camera shake when recording a video as is known in the art.

FIG. 3 shows an example of use of the second mode of operation. In the second mode, shutter button 205 is pressed when imaging device 100 is in a first position 304a. At this point, field of view portion 302a is stored as image data in imaging device 100. Then, the photographer will slowly pan across field of view 302 by rotating imaging device 100 about y-axis 208. As this is done, motion sensor 152 (FIG. 1) sends host CPU 165 signals indicating relative rotation of imaging device 100. Each time imaging device 100 has rotated by displacement angle Δα host CPU 165 causes the current image to be stored. This happens in succession as field of view portions 302a, 302b, 302c are successively stored automatically in response to rotation of imaging device 100 through arc angle α₂. In one embodiment, when the user releases shutter button 205 at final position 304d, a final image of corresponding field of view portion 302d is stored. The total angle of view will therefore be the sum of the angle of view a of imaging device 100 plus the arc angle α₂. If imaging device 100 generates a video stream, then each frame of video may be discarded, except ones that arrive when imaging device 100 has rotated by predetermined displacement angle 312. The images that are not discarded may be stored as individual files in memory 167 as described above.

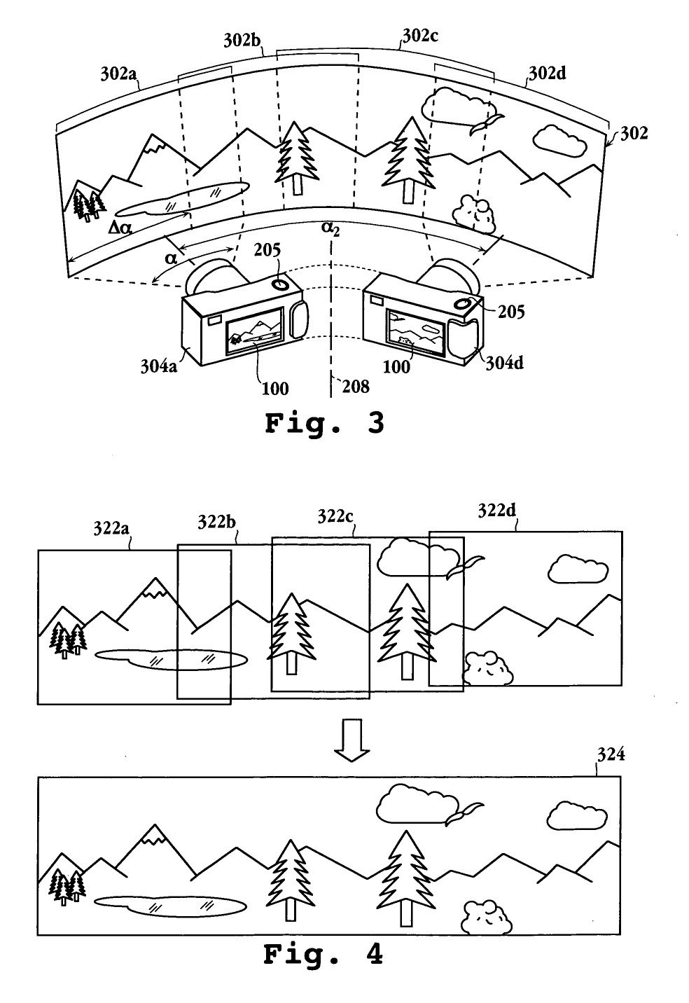

FIG. 4 shows how overlapping images 322a, 322b, 322c, and 322d can be stitched together to create a final image 324. In one embodiment, imaging device 100 includes firmware for stitching images 322a-322d together. Depending on the processing power of imaging device 100, the stitching operation can begin concurrently with multi-image capture immediately after the second image in the series is captured.

Image stitching algorithms wherein two or more overlapping images are combined into a single seamless image are known in the art. In general terms, in an image stitching operation, overlapping images are compared with each other to determine where the images overlap in an initial alignment operation. This may be performed computationally. For example, some algorithms identify and match up edges within each image. An edge is a line between two contrasting areas. For example, an edge might exist between a mountain and the sky or various features within the mountain. Once edges are identified for each image, the edges are compared from one image to the next to determine likely matches. If a match is made, then the overlapping images are digitally stitched together to form final image 324 in a merging operation. The merging operation may include some transformation/dewarping of the images to compensate for the differing perspectives between images. This transformation may comprise computationally flattening the projection of the sequence of images taken on the arc for presenting a final flat two dimensional image. Displacement angle information from motion sensor 152 may be used in the transformation operation. The merging operation can also include a final cropping so that misalignments between successive images can be hidden.

The alignment and merging operations can be done independently of one another. For example, each image may be aligned and merged with a previous image as each image is captured during multi-image capture. In another embodiment, all images 322a-322d may be first aligned in a first step, then merged in a second step. In another embodiment, each image is aligned with a previous image during and/or after the multi-image capture and then all the alignment information is gathered and each image is placed into a final larger image, which is then stored in memory.

In another embodiment, images are stored separately in memory 167 to be later stitched together using a general purpose computer. In this embodiment, host CPU may add meta data to each image file header to identify each overlapping image 322a-322d as one of a plurality of overlapping images. The meta data may include identifying the image number in the sequence of images for each image and/or a displacement vector in the header file for each image after the first in the series. The displacement vector can provide the approximate number of pixels vertically and/or horizontally, of image displacement from the previous image in the series. This can be used by a stitching algorithm as a hint or starting location for aligning overlapping images. If imaging device has a three-axis motion sensor, then a rotation angle about z-axis 210 (FIG. 2) can also be provided in the meta data to further assist the stitching algorithm, in case the camera is rotated about the z-axis between images.

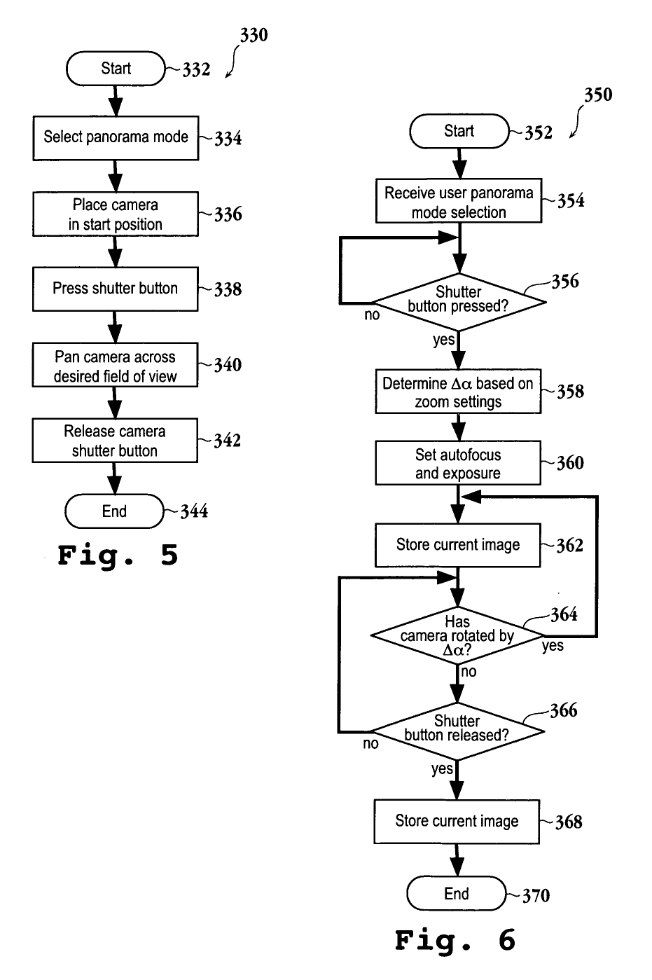

FIG. 5 shows a flowchart 330 describing an exemplary procedure for taking a panorama image using imaging device 100. The procedure starts as indicated at start block 332 and proceeds to operation 334 wherein the user may select a panorama mode. The user may enter a panorama mode by making a selection using a camera dial (typically found on the top of cameras) to select operation mode, electronic user interface, or other user input mechanism. Selecting a mode allows the camera to perform differently depending on the photographer's need. For example, in one mode, the camera may take continuous still photos at, e.g., 2 frames per second when the shutter button is held down, while in an “panorama” or “overlap” mode, the camera operates as described below. In an alternative embodiment, this mode-selection operation is skipped and imaging device infers mode between single shots and panorama by how long shutter button 205 (FIG. 2) is held, as will be described in further detail below. If imaging device 100 infers the mode, then the user may proceed immediately to operation 336, otherwise, the user proceeds to operation 336 after selecting the panorama mode. It will be noted that “panorama mode” may refer to any mode generating multiple overlapping images, whether in horizontal or vertical directions, or both.

In operation 336, the user orients imaging device 100 so that the view finder 214 or LCD 216 (FIG. 2) shows a portion of the full field of view desired to be captured. If imaging device 100 includes zoom functionality, then a zoom setting may be selected by the photographer at this time. A high zoom factor using an optical zoom lens can be used to artificially increase the resolution of an image by taking multiple overlapping images of the scene and combining them together to form a single high resolution image. The portion initially shown will generally be at one end or another of the full field of view. For example, when taking a picture for an extra wide aspect ratio, imaging device 100 may be oriented to view the far left of the scene as shown as position 304a in FIG. 3 or the far right of the scene as shown as position 304d in FIG. 3. After initially orienting imaging device 100, the procedure flows to operation 338.

In operation 338, the user presses shutter button 205 (FIG. 2) and holds it down. If the user mode of imaging device 100 is inferred as discussed above with respect to operation 334, then imaging device 100 can infer whether a panorama shot is desired by measuring the length of time shutter button 205 remains depressed. After pressing shutter button 205, the user proceeds to operation 340, in which the user pans imaging device 100 across the intended field of view. In one embodiment, the photographer ensures that the panning operation be performed smoothly and slowly, to make sure each shot is clear and provide imaging device 100 with sufficient time to store each successive shot in memory. In one embodiment, the photographer continues holding shutter button 205 down while panning, to indicate his or her intention to capture additional photos of the extended field of view. It is possible for the photographer to rotate imaging device about x-axis 206 as well as y-axis 208 (FIG. 2) in a serpentine pattern for the purpose of obtaining an extra wide and extra tall (high resolution) image of the scene. After reaching the end of the intended field of view, the photographer proceeds to operation 342.

In operation 342, shutter button 205 (FIG. 2) is released. The procedure then ends as indicated by ending block 344. In one embodiment, imaging device 100 performs an image stitching operation during or after completion of the multi-image capture. Such a stitching operation may take place in any well-known conventional manner, assisted by the meta-data displacement vector mentioned above. In another embodiment, device 100 may lack adequate processing power to perform an image stitching operation. In this case, the photographer can upload the images to his or her general purpose computer, or to a photo processing center computer where the overlapping images may be identified using meta data stored in the image header files and/or filename whereupon the general purpose computer may automatically stitch overlapping images together to form single high-resolution and/or wide-angle images. Again, the general purpose computer can perform the stitching operation in the conventional manner, but with assistance of the meta data, including displacement vector information as described above.

FIG. 6 is a flowchart 350 showing the same procedure as in FIG. 5, but from the standpoint of imaging device 100. The procedure begins as indicated by starting block 352 and flows to operation 354.

In operation 354, imaging device 100 receives a user panorama mode selection. In one embodiment, this operation is skipped and the user mode is inferred by how long the user holds down shutter button 205 or its equivalent. If imaging device infers the user mode, then the procedure skips to operation 356. Otherwise, the procedure flows to operation 356 upon selection by the user of the panorama mode.

In operation 356, imaging device 100 determines whether shutter button 205 (FIG. 2) has been pressed. If not, then the imaging device 100 waits until shutter button is depressed as indicated by the “NO” arrow feeding back to operation 356. Once the shutter button is depressed, the procedure flows to operation 358.

In operation 358, an displacement angle Δα is determined based on current zoom setting (if any). If imaging device 100 has a zoom feature, then the angle of view can be calculated based on the zoom setting. As discussed above, the zoom setting may include an optical zoom, which varies the focal length, and/or a digital zoom, which varies the effective size of the sensor. Displacement angle Δα is determined for vertical and horizontal directions based on the vertical and horizontal angle of view. For example, if a field of view is 30° horizontally and 20° vertically (for an imaging device having a 3:2 aspect ratio) then the displacement angle Δα may be calculated as 2Δα/3 or 20° horizontal and 14° vertical. After calculating displacement angle Δα, the procedure flows to operation 360.

In operation 360, imaging device determines autofocus and exposure settings. Autofocus settings and exposure settings can be determined in any convenient manner consistent with the foreseeable application of the device. In one embodiment, autofocus is achieved by taking one or more preview images and, using software and/or hardware implemented algorithms, analyzing appropriate regions of the image for contrast. In addition to determining an appropriate autofocus setting, imaging device 100 can also determine an appropriate exposure setting. Exposure setting can be determined concurrently with autofocus using the preview image and identifying the brightness level of the scene and compensating for the brightness level. If a flash is used, then a pre-flash can be used when taking the pre-image to assist in both autofocus and exposure. After autofocus and exposure is set, the procedure continues with operation 362.

In operation 362, the current image is stored. Referring to FIG. 1, host CPU 165 instructs graphics controller 140 to obtain a new image from imaging module 110 and then copies the image from a frame buffer in graphics controller 140 to memory 167. If imaging device generates a video stream, then the current image is the current frame received from imaging module 110. In one embodiment, if the image is the first image of a series of overlapping images, the image may simply be stored in an image buffer so that subsequent images can be stitched together using known stitching algorithms. As new images are added, they can be stitched using host CPU 165 with previous images. Sensor information can be used to assist in the stitching operation, as a starting point in aligning images together. This can significantly reduce the processing power required to align overlapping images with one another. If motion sensor 152 includes a tilt detection sensor, e.g., one which responds to the pull of gravity to provide an absolute angle of tilt with respect to horizontal, then perspective correction can be automatically applied to reduce perspective distortion effects when taking images of tall buildings, for example.

In a second embodiment, the current image data may be compressed into a compressed-image file format, to be opened and later stitched with previous and/or subsequent images using a general purpose computer. In this case, host CPU 165 may add header information to the image file to store metadata to indicate that the image is one of a series of overlapping images, and to indicate the position of the image in the series. In this regard, a counter is incremented each time operation 362 is executed and the counter value is added to the header for the corresponding image. In addition, the filename used to identify the image may be modified to indicate that the image is one of a series of overlapping images, e.g., by appending a letter or number to the filename. The metadata may also include a displacement vector and other information to assist computer software when stitching the overlapping images together. The displacement vector can be expressed as a number of pixels in the x and y directions, and, if the z-axis is monitored by host CPU 165, then an angle of rotation about the z-axis can also be provided. Rotation about the z-axis by the photographer will result overlapping images being rotated with respect to each other. When stitching the images together, this rotation will require digitally rotating the images to compensate, so that objects visible in the images, such as the horizon, line up properly. After storing the current image, the procedure flows to operation 364.

In operation 364, host CPU determines whether the camera has rotated by the displacement angle ha. To do this, host CPU keeps track of relative rotation of the camera about y-axis 208 and/or x-axis 206 (FIG. 2) based on signals from motion sensor 152 (FIG. 1). For example, motion sensor 152 may include a circuit that provides a value or a plurality of values readable by host CPU 165 that indicates rotation about one, two, or three axes over a period of time. The rotation amount for each axis may be initialized to zero each time shutter button is pressed in operation 356 and after each image store operation. Thus, if the rotation amount exceeds the displacement angle Δα for either the x-axis or y-axis, then the procedure flows to operation 362 to store the current image and the total rotation values are reset to zero. If the total rotation amount for the x and y axes are less than the corresponding displacement angle 11a for each axis, then the procedure flows to operation 366. If imaging device 100 generates a video stream, then any frames captured before the predetermined displacement angle is reached by the amount of rotation are discarded or are allowed to be overwritten.

In operation 366, host CPU determines whether shutter button 205 (FIG. 2) has been released. If shutter button 205 has not been released, then the procedure flows back to operation 364. If the shutter button 205 has been released then the procedure flows to operation 368.

In operation 368, the current image is stored in the manner described above with respect to operation 362. If imaging device 100 is configured to infer the operating mode based on the amount of time shutter button 205 is held down, then this operation is skipped if the shutter button has not been held longer than some threshold length of time, e.g., one-half of a second or a second. After storing the current image, or skipping the operation of storing the image if the shutter button 205 is not been down for the threshold length of time, the procedure ends as indicated by ending block 370.

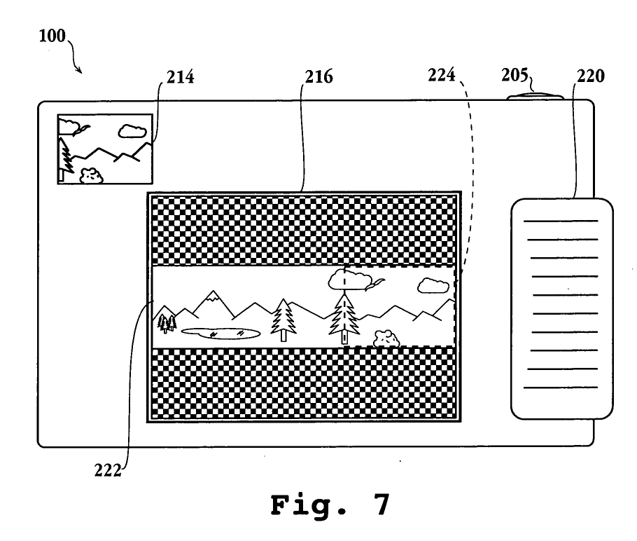

FIG. 7 shows detail view of the back of imaging device 100 during multi-image capture. As mentioned previously, imaging device 100 may include an optical viewfinder 214 and/or an LCD display 216, along with hand-grip 220. One advantage of the panorama mode described above, is that the user no longer is required to refer to a rear-panel LCD to ensure a proper amount of overlap when taking successive overlapping images. Instead, the photographer can simply view a scene through optical viewfinder 214 when composing and taking the images. Since an electronic display is not required, a compact imaging device 100 capable of generating overlapping or panorama images may be manufactured for a very low cost.

In the case where LCD 216 is available, it may be utilized differently than in prior panorama-capable cameras. Specifically, LCD 216 may provide feedback to the photographer as to the progress of the panorama image. In one embodiment, the camera takes and stores successive overlapping images to be stitched together at a later time using a general purpose computer. However, the display can provide an estimated finished stitched image using data from motion sensor 152 (FIG. 1). In this embodiment, an assembled panorama image 222 is scaled down and displayed on LCD 216 while the images are being taken. Live preview image 224 overlays panorama image 222 at a location relative the panorama iamge 222, which comprises the combined previous images 322a, 322b, and 322c (FIG. 4). Thus, when an image is captured, it is frozen and combined with the panorama image 222. Subsequently, the live image overlays the newly stretched panorama image 222. In one embodiment, the live preview is identified with a flashing or colored border (represented in FIG. 7 as a dashed line).

In another embodiment, images are aligned and stitched together in imaging device 100. In this example, LCD display 216 provides feedback as to the progress of the image capture as well as image stitching. In this case, LCD display 216 displays a live preview image 224 as well as estimated alignments of combined previous images. Images not yet aligned and stitched together may be shaded or colored (not shown in FIG. 7). In this way, the photographer can have better control and instant feedback of the multiple image capture process.

The methods and systems described above may be augmented to provide additional features. For example, an optional mode may be entered into wherein the focus is adjusted for each of the overlapping images. Another mode may be entered into for generating a spherical image of a virtual scene. In this case, the photographer may be required to rotate imaging device 100 a complete 360° then tilt the camera up (or down) and rotate another 360°, and continue this process until the camera is pointing up or down. Once these images are stored, they can then be combined to generate a virtual scene in a computer that allows a user to view the scene at any angle. In another embodiment, perspective correction can be applied during image stitching. In this example, motion sensor 152 (FIG. 1) includes a gravity sensor to detect an amount of tilt. Thus, when the photographer tilts imaging device 100 up or down, e.g., when photographing a building or a waterfall, host CPU can automatically correct for distortion (sometimes referred to as “keystoning”) caused by the tilting. Additional enhancements and/or augmentations may occur to those skilled in the art which are consistent with the spirit and scope of this invention.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for capturing a plurality of overlapping images using an imaging device, the method comprising:
receiving input indicating a start of a multi-image capture;
storing a first image of the plurality of overlapping images;
measuring an amount of rotation of the imaging device about at least one axis from a time of storing a most recently stored image;
storing a subsequent image of the plurality of overlapping images each time the amount of rotation exceeds a displacement angle;
receiving input indicating an end of the multi-image capture.

2. The method of claim 1, wherein the input indicating the start of the multi-image capture comprises a signal indicating that a shutter button has been depressed, and the input indicating the end of the multi-image capture comprises a signal indicating that the shutter button has been released.

3. The method of claim 1, wherein the storing a first image comprises copying image data representing the first image to a memory and the storing a subsequent image comprises copying image data representing the subsequent image to a memory.

4. The method of claim 1, wherein the measuring the amount of rotation comprises measuring only an amount of yaw.

5. The method of claim 1, wherein the measuring the amount of rotation comprises measuring an amount of yaw and an amount of pitch, the displacement angle being a yaw displacement; the method further comprising comparing the amount of yaw with the yaw displacement and comparing the amount of pitch with a pitch displacement; wherein the storing the subsequent image comprises storing the subsequent image each time the amount of yaw exceeds the yaw displacement and each time the amount of pitch exceeds the pitch displacement.

6. The method of claim 5, wherein the storing the subsequent image further comprises:
generating an image header containing metadata for each stored image, the metadata comprising a displacement vector providing an approximate amount of displacement between the most recently stored image and the subsequent image; and
creating an image file for the subsequent image, the image file including the image header.

7. The method of claim 6, wherein the displacement vector is expressed in terms of a number of horizontal pixels and a number of vertical pixels that subsequent image is displaced from the most recently stored image.

8. The method of claim 1, further comprising:
determining the displacement angle based on a current zoom setting, the zoom setting including at least one of an optical zoom setting for adjusting a focal length, and a digital zoom setting for adjusting an effective size of an image sensor.

9. The method of claim 1, further comprising:
determining whether the imaging device is in a normal mode or a multi-image capture mode; and
when the imaging device is in the multi-image capture mode, storing a final image of the plurality of overlapping images after receiving the input indicating the end of the multi-stage capture.

10. The method of claim 9, wherein the determining whether the imaging device is in the normal mode or the multi-image capture mode comprises:
measuring an amount of time elapsed from a time of receiving the input indicating the start of the multi-image capture and a time of receiving the input indicating the end of the multi-image capture, wherein the imaging device is in the multi-image capture mode when the amount of time elapsed exceeds a threshold amount of time.

11. The method of claim 1, further comprising:
stitching the first image with at least one said subsequent image, wherein the storing the first image, the measuring, the storing the subsequent image, and the stitching are performed internal to the imaging device, the stitching comprising aligning the plurality of overlapping images and merging the plurality of overlapping images; the aligning further comprising using the amount of rotation as a starting point when seeking an actual alignment.

12. The method of claim 1, further comprising displaying an approximation of a stitched image formed from the plurality of overlapping images, the approximation being formed by combining previous ones of the plurality of overlapping images using the measured amount of rotation of the imaging device to position the overlapping images with respect to each other.

13. The method of claim 12, further comprising, overlaying a live preview image on the approximation, the live preview image being positioned relative the approximation using the measured amount of rotation, the live preview image being frozen and combined with the approximation at a time of the storing.

14. An imaging device for taking multiple overlapping images, the imaging device comprising:
an input device, the input device providing a signal indicating a start of a multi-image capture and a signal indicating an end of a multi-image capture in response to user interaction;
an image sensor for capturing the multiple overlapping images;
a first image store circuit configured to cause a first image of the multiple overlapping images to be stored in response to the signal indicating the start of the multi-image capture;
a motion sensor circuit configured to measure an amount of rotation of the imaging device about at least one axis from a time of storing a most recently stored image;
a subsequent image store circuit configured to cause a subsequent image to be stored each time the amount of rotation exceeds a displacement angle until the signal indicating the end of the multi-image capture is received from the input device.

15. The imaging device of claim 14, wherein the input device comprises a shutter button, the shutter button generating the signal indicating the start of the multi-image capture when the shutter button is depressed and generating the signal indicating the end of the multi-image capture when the shutter button is released.

16. The imaging device of claim 14, wherein the motion sensor circuit comprises a gyroscopic motion sensor.

17. The imaging device of claim 14, wherein the motion sensor circuit measures only an amount of yaw.

18. The imaging device of claim 14, wherein the motion sensor circuit measures an amount of yaw and an amount of pitch, the displacement angle being a yaw displacement; wherein the subsequent image store circuit compares the amount of yaw with the yaw displacement and the amount of pitch with a pitch displacement, the subsequent image being stored each time the amount of yaw exceeds the yaw displacement and each time the amount of pitch exceeds the pitch displacement.

19. The imaging device of claim 18, further comprising:
a circuit configured to create an image file for the subsequent image, the image file including an image header, the image header containing metadata, the metadata including a displacement vector providing an approximate amount of displacement between the most recently stored image and the subsequent image.

20. The imaging device of claim 14, further comprising:
a zoom apparatus, the zoom apparatus selectively adjusting an angle of view of the imaging device, the zoom apparatus including at least on of an optical zoom for adjusting a focal length and a digital zoom for adjusting an effective size of the image sensor; and
a circuit configured to determine the displacement angle based on a current zoom setting of the zoom apparatus.

21. The imaging device of claim 14, further comprising:
a mode select circuit configured to select between a normal mode or a multi-image capture mode; and
a final image store circuit configured to store a final image of the multiple overlapping images after receiving the input indicating the end of the multi-stage capture when the imaging device is in the multi-image capture mode.

22. The imaging device of claim 21, wherein the mode select circuit measures an amount of time elapsed from a time of receiving the signal indicating the start of the multi-image capture and a time of receiving the signal indicating the end of the multi-image capture, wherein the multi-image capture mode is selected when the amount of time elapsed exceeds a threshold amount of time.

23. The imaging device of claim 14, further comprising:
an image stitch circuit configured to stitch the first image with at least one said subsequent image, the image stitch circuit performing an aligning operation to align the plurality of overlapping images and a merging operation to merge the plurality of overlapping images; wherein the circuit uses the amount of rotation as a starting point in the alignment operation.

24. The imaging device of claim 14, further comprising an optical viewfinder, the imaging device not having an electronic display.

25. The imaging device of claim 14, further comprising an electronic display, and a display circuit for displaying an approximation of a stitched image formed from the multiple overlapping images, the approximation being formed by combining previous ones of the multiple overlapping images using the measured amount of rotation of the imaging device to position the overlapping images with respect to each other.

26. The imaging device of claim 25, wherein the display circuit, overlays a live preview image over the approximation, the live preview image being positioned relative the approximation using the measured amount of rotation, the live preview image being frozen and combined with the approximation at a time of the storing.
